(19) United States
(12) Patent Application Publication
(10) Pub. No.: US 2020/0143336 A1
(43) Pub. Date: May 7, 2020

(54) SYSTEM AND METHOD FOR A CIRCULAR WASTE RECYCLING ECONOMY UTILIZING A DISTRIBUTED LEDGER

(71) Applicant: Klean Industries, Inc., Vancouve (CA)

(72) Inventor: JESSE KLINKHAMER, SURREY (CA)

(21) Appl. No.: 16/659,719

(22) Filed: Oct. 22, 2019

Related U.S. Application Data
(60) Provisional application No. 62/755,676, filed on Nov. 5, 2018.

(51) Int. Cl. G06Q 20/06; H04L 9/06; H04L 29/06; G06Q 30/08

(52) U.S. Cl. CPC G06Q 20/06; H04L 9/0643; H04L 2209/38; G06Q 30/08; H04L 63/0869

(57) ABSTRACT

The disclosure generally relates to systems and methods for a circular waste economy platform consisting of waste sellers, waste buyers, and waste transport providers, where the platform utilizes artificial intelligence to facilitate the sale, transfer, and fulfillment of waste between sellers and buyers, and where the waste transactions are recorded on a distributed ledger.

### CROSS REFERENCE TO RELATED APPLICATION

This application claims the benefit of U.S. Provisional Patent Applications No. 62/755,676 entitled “SYSTEM AND METHOD FOR FACILITATING WASTE RECYCLING TRANSACTIONS UTILIZING A DISTRIBUTED LEDGER” filed on Nov. 5, 2018 which is commonly owned, the disclosure of which is incorporated herein by reference in its entirety.

### BACKGROUND

### Field of the Invention

The disclosure generally relates to systems and methods for a circular waste economy platform consisting of waste sellers, waste buyers, and waste transport providers, where the platform utilizes artificial intelligence to facilitate the sale, transfer, and fulfillment of waste between sellers and buyers, and where the waste transactions are recorded on a distributed ledger.

### Description of Related Art

The world is currently facing significant environmental challenges based on the massive population growth of the 21st century. The cost of energy, commodity, and raw materials continue to rise along with an ever-increasing volume of waste materials and pollution being produced globally. Furthermore, disposal of a wide variety of waste materials inherently poses handling and disposal challenges. Increases in landfill deposit rates have also created a deficit of landfill space that must constantly be addressed by the waste recycling and waste management industry.

As such, there is an increasing demand for more efficient and responsible waste management, and reuse of waste materials, due to a growing eco-consciousness by the public, corporations, and governments. For example, new regulations are constantly being established by state, local, and national governments that include prohibiting certain types of waste materials from landfills, such as electronic waste, scrap tires, plastic-derived product waste, and the like. Such regulations, along with efforts to increase recycling adoption, have placed significant pressure on waste generators and other business entities participating in the waste management and recycling supply chain to adopt sustainable, transparent, accountable, and verifiable waste management practices.

However, the practical aspects in terms of costs and logistics of waste recycling and reuse raise challenges for waste generators to efficiently participate in a recycling economy. The present invention addresses these challenges, in part, by using artificial intelligence to match waste generators (i.e., sellers) to entities seeking to purchase waste for reuse, repurposing, and/or recycling (i.e., buyers), while also matching waste transport providers who facilitate the logistical aspects of waste pick-up and delivery for the parties involved. In addition, the present invention provides a financial incentive by allowing waste generators to sell their waste materials, thereby creating an incentivized circular waste recycling economy that is not offered by conventional waste management and recycling solutions.

In addition, conventional waste recycling and management supply chains cannot track and verify a waste transport provider's status, credentials, and location in real time, and record the provider's transactions to and from waste pick-up and delivery sites. Without a system to verify, at the time of pickup and delivery, the waste being picked up/delivered, the value of the waste, the credentials of the waste transport provider, conventional waste management and recycling systems are prone to abuse, mismanagement, delays, fraud, and theft of waste destined to a recycling facility or an end-user buyer.

Therefore, there is a need for systems and methods that allow waste sellers to receive a real-time, or near-real time, offer to purchase waste materials using a distributed circular waste economy platform, where multiple buyers can quickly and efficiently provide offers to purchase the seller's waste materials, and where a waste transport provider is efficiently matched with the buyer and seller to fulfill the waste transaction, whereby the entire waste transaction is securely recorded and stored in a distributed ledger, and where the participants can transact using virtual currencies.

### SUMMARY

In one embodiment, the invention relates to a system for a circular waste recycling economy platform, comprising: a server comprising a central processing unit (CPU); at least one seller communicatively coupled to the server, wherein the seller owns a waste lot; a plurality of buyers communicatively coupled to the server; a plurality of waste transport providers communicatively coupled to the server; and a distributed ledger communicatively coupled to the server, wherein the server is further configured to match the waste lot to at least one buyer using an artificial intelligence technique, and wherein the server is configured to transmit an offer to sell the waste lot from the seller to the at least one buyer that is matched by the server, and wherein the server is further configured to generate a smart contract for a sale of the waste lot between the seller and the at least one buyer, and wherein the distributed ledger is configured to store the smart contract.

In another embodiment, the invention relates to a method for conducting waste transactions, comprising: receiving, at a server, an image of a waste lot from a waste seller; analyzing, by the server, the image of the waste lot to identify at least waste item in the image; generating, by the server, an offer bid for the waste lot, wherein the offer bid is generated using an artificial intelligence technique; transmitting, by the server, the offer bid to the waste seller; executing, by the server, a first operation to transmit the offer bid to a plurality of waste buyers communicatively coupled to the server if the waste seller approves the offer bid, or executing, by the server, a second operation to analyze a counter bid from the waste seller if the waste seller rejects the offer bid; accepting, by a waste seller, the offer bid; generating, by the server, a smart contract for a sale of the waste lot between the waste seller and the waste buyer; storing, by the server, the smart contract on a distributed ledger communicatively coupled to the server; identifying, by the server, a waste transport provider to service the sale of the waste lot; receiving, by the server, funds from the waste buyer to fulfill the smart contract; distributing, by the server, the funds to the waste seller and the waste transport provider upon confirmation of a delivery of the waste lot to the waste buyer by the waste transport provider; and updating, by the server, the smart contract with at least one of a waste lot delivery confirmation and a funds transfer confirmation.

In yet another embodiment, the invention relates to a system for a circular waste recycling economy platform, comprising: a server communicatively configured to operate a closed network accessible only to entities that have been granted access to the closed network by the server; a seller decentralized application (DApp) operated by a waste seller, the seller DApp communicatively coupled to the server; a buyer DApp operated by a waste buyer, the buyer DApp communicatively coupled to the server; a distributed ledger communicatively coupled to the server; and a central processing unit (CPU) coupled to the server, wherein the CPU is configured to match the waste buyer to the waste seller using an artificial intelligence technique, wherein the server is configured to transmit an offer bid for a waste lot for sale by the waste seller to the waste buyer, wherein the server is further configured to transmit at least one of an acceptance and a counter offer from the waste buyer to the waste seller, wherein the server is further configured to generate a smart contract for the sale of the waste lot between the waste buyer and the waste seller, where the smart contract is stored on the distributed ledger, and wherein the server is further configured to act as an escrow agent to hold funds from the waste buyer until the waste lot is successfully delivered to the waste seller.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows an exemplary block diagram of a network architecture for a circular waste economy platform, according to an embodiment of the present invention;

FIG. 2 shown an exemplary distributed ledger structure, according to an embodiment of the present invention;

FIG. 3 is a flowchart depicting the steps for conducting an auction for a waste lot, according to an embodiment of the present invention;

FIG. 4 is a flowchart depicting the steps for scheduling a waste transport provider and fulfilling a waste lot pick-up and delivery, according to an embodiment of the present invention;

FIG. 5 is a flowchart depicting the steps of conducting a financial transaction for the transfer of a waste lot utilizing a distributed ledger, according to an embodiment of the present invention;

FIG. 6 is an exemplary diagram of a DApp interface that allows a seller to input a waste lot, according to an embodiment of the present invention;

FIG. 7 is an exemplary diagram of a DApp interface that displays a list of waste items in a waste lot, according to an embodiment of the present invention;

FIG. 8 is an exemplary diagram of a DApp interface that allows a seller to input auction details, according to an embodiment of the present invention; and

FIG. 9 is an exemplary diagram of a DApp interface that allows a seller to review an offer bid for a waste lot, according to an embodiment of the present invention.

### DEFINITIONS

The following definitions are meant to aid in the description and understanding of the defined terms in the context of the present invention. The definitions are not meant to limit these terms to less than is described throughout this application. Such definitions are meant to encompass grammatical equivalents.

As used herein, the term “waste” can refer to, for example, plastic waste (including, but not limited to, Polyethylene Terephthalate (“PETE” or “PET”), High-Density Polyethylene (“HDPE”), Low-Density Polyethylene (“LDPE”), Polystyrene or Styrofoam (“PS”), Polyvinyl Chloride (“PVC”), Polypropylene (“PP”)), tires, scrap tires, tire-derived products, human waste, solid municipal waste, wastewater, household refuse, organic waste, bio-hazardous waste, toxic waste, environmental waste, yard waste, regulated medical waste, electronic waste, post-consumer waste, pre-consumer waste, construction debris, bottles, aluminum cans, scrap metal, and the like.

As used herein, the term “electronic waste” can refer to, for example, whole devices, such as televisions, batteries, power supply adapters, computers, mobile phones and tablet computers, audio and video recorders, cameras, printers, peripheral devices, keyboards, and countless other electronic devices, networking cables and wires, as well as electronic parts, components, and raw materials used in the manufacturing of electronic devices.

As used herein, the term “computing device” can refer to, for example, mobile phones, still and video cameras, portable media players, desktop computers, laptop computers, netbooks, smartphones, tablet computers, wearable devices, “smart” watches, “smart” bracelets, “smart” necklaces, enhanced vision devices and systems, augmented vision headsets/glasses, internet-connected streaming media devices, security and surveillance devices, and the like.

As used herein, the term “artificial intelligence” can refer to, or can incorporate, for example, machine learning, deep-learning, supervised learning, unsupervised learning, semi-supervised learning, reinforced learning, fuzzy logic, neural networks, historical data and pattern analysis, and the like.

As used herein, the term “virtual currency” and “virtual currencies” can refer to, for example, digital currency (unregulated or regulated), cryptocurrency, electronic tokens or coins, virtual money, proprietary or closed virtual currencies, public or open virtual currencies, and any regulated or unregulated non-fiat currency that is controlled by its developers and used and accepted among the members of a specific virtual community.

As used herein, the term “distributed ledger” can refer to, for example, a shared ledger, a block lattice, a hash-graph network, a blockchain, and various distributed ledger technology (“DLT”), which can consist of a consensus of replicated, shared, and synchronized digital data geographically spread across multiple sites, countries, or institutions, with or without a central administrator or centralized data storage.

### DETAILED DESCRIPTION

It should be understood that aspects of the invention are described herein with reference to the figures, which show illustrative embodiments. The illustrative embodiments herein are not necessarily intended to show all embodiments in accordance with the invention, but rather are used to describe a few illustrative embodiments. Thus, aspects of the invention are not intended to be construed narrowly in view of the illustrative embodiments. In addition, although the invention is described with respect to its application for the recycling of e-waste, it is understood that the invention could be implemented for various types of waste in any setting where the transfer, transport, sale, and/or recycling of any type of waste or by-products is desired.

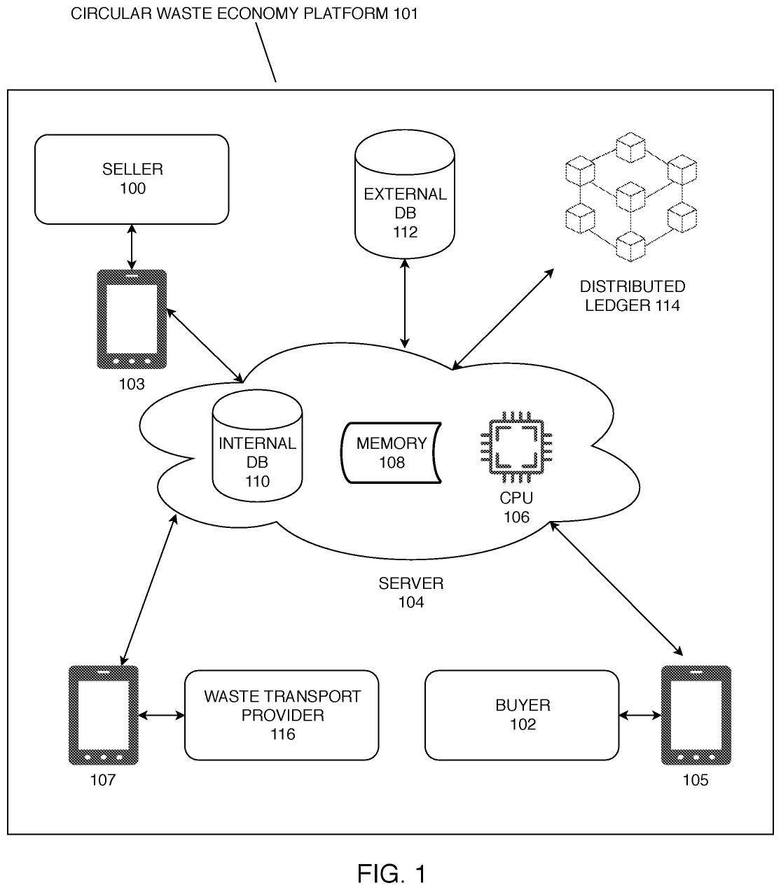

FIG. 1 shows an exemplary block diagram of a network architecture for a circular waste economy platform 101, according to an embodiment of the present invention. The circular waste economy platform 101 facilitates the transfer of waste products from a seller 100 to at least one buyer 102. The seller 100 can be an individual, such as, for example, a homeowner or business owner, or the seller 100 can be an organization, such as a business, governmental entity, academic institution, a not-for-profit, waste collection agency, waste aggregator, a waste generator, an entity that acquires bulk waste, and the like. In a preferred embodiment, the seller 100 is an entity that owns waste or generates waste, and which desires to dispose such waste in exchange for financial compensation.

The seller 100 can have a computing device 103 that is communicatively coupled to a server 104. The server 104 may be located remotely from the seller 100. The computing device 103 communicates with the server 104 via a network, such as a wireless network, a cellular network, a landline network, or a short-range connection (i.e., Bluetooth, Zigbee, infrared, etc.). In an embodiment, the computing device 103 can be any computing device capable of connectivity to the server 104 via a network. In an embodiment, the computing device 103 is held or worn by, or coupled to, the seller 100. In another embodiment, the computing device 103 can be permanently or removably affixed to a structure, such as a vehicle interior or exterior (i.e., garbage truck, truck, car, van, airplane, drone, golf cart, bulldozer, construction vehicles, landscaping vehicles, etc.), a distance measuring wheel, or surveying equipment.

In operation, the seller 100 can capture an image of a waste lot with the computing device 103. The image is not limited to a still image, and can include video data, audio data, three-dimensional coordinates, and spatial data. The waste lot image can include, partially or in its entirety, an item of waste, or a waste lot consisting of multiple items of waste (collectively, a “waste lot”) which the seller 100 desires to sell, recycle, reuse, repurposes, and/or have removed from its location.

In an embodiment, the server 104 can be operated and/or maintained by a third-party, such as a platform provider (not shown). The platform provider may grant or deny access to entities wishing to participate on the circular waste economy platform 101, and the platform provider may charge a fee, such as a membership fee, to participants of the circular waste economy platform 101. The circular waste economy platform 101 can be a closed network that is not open to the public at large.

In an embodiment, the platform provider receives a commission based on a transaction amount of a waste lot transaction. In another embodiment, the platform provider can receive a flat fee for a waste lot transaction, regardless of the transaction amount.

In an embodiment, the server 104 includes artificial intelligence computing capabilities, whereby various value/price calculations, buyer and seller matching, waste transport provider matching, waste identification, and the like, can leverage data processing and insights garnered from artificial intelligence techniques in order to make efficient and optimal decisions and calculations.

In an alternative embodiment, the server 104 can be downloaded or installed locally on the computing device 103, such as in the form of a software application. The server 104 can include a communication transceiver, communication protocol software, application layers, a central processing unit 106 (CPU), a memory 108, and an internal database 110.

The server 104 can further be coupled to an external database 112 in addition to the internal database 110. For example, the internal database 110 may include participant lists, such as seller, buyer, and waste transporter lists, as well as pricing data, financial data, etc. The external database 112 may include map and navigation data, waste supply and demand data, fuel cost data, commodities data, and weather data that is received or aggregated from third-party sources.

In an embodiment, the memory 108 can store algorithms, formulas, and mathematical models (collectively, “software”) which can be executed by the CPU 106. The software can include algorithms and scripts for artificial intelligence processing by the CPU 106. The software can further be used to facilitate various waste management and recycling supply chain functions by the CPU 106, which are described in more detail herein, and which include, but are not limited to, performing image analysis, matching sellers with buyers, facilitating an auction/bid process, facilitating waste purchase transactions, matching waste transporters with waste pick-up and delivery needs, executing waste transactions, and the like.

In another embodiment, the server 104 can include a single database that combines and maintains data from multiple sources, both proprietary sources and external sources, where the external sources are refreshed by the server 104 on a periodic basis.

In yet another embodiment, the server 104 can initiate a direct peer-to-peer communication between the seller 100 and buyer 102, where the participants communicate and exchange data using their respective computing devices 103, 105. The direct peer-to-peer communication can be encrypted and include security protocols.

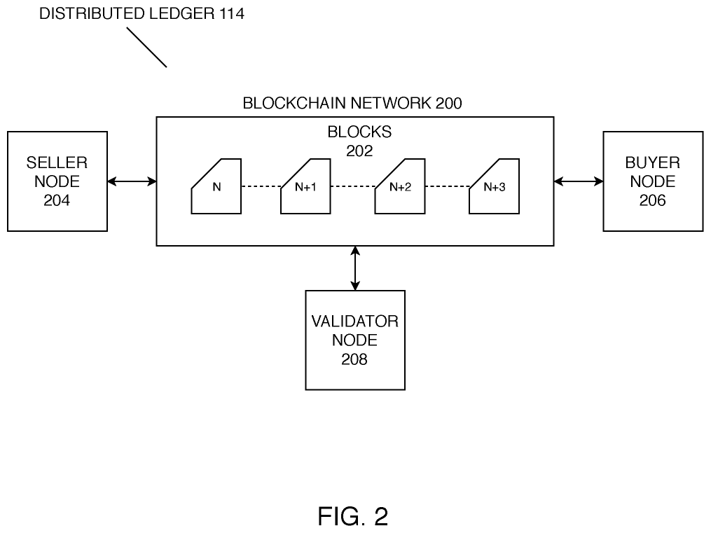

In a preferred embodiment, the server 104 includes, or is communicatively coupled to, a distributed ledger 114. The distributed ledger 114 is a decentralized distributed database that consists of a blockchain network, as described in more detail herein in FIG. 2. The blockchain can include data structure blocks which represent waste lot transactions, buyer and seller data records and/or applications (such as, for example, smart contracts).

In an embodiment, the distributed ledger 114 can include not only a blockchain network, but also a block lattice network, hash-graph network, and the like. It will be apparent to a person skilled in the art that the invention is not limited to any type of distributed ledger mentioned above and is relevant to all variations and implementations of the distributed ledger 114.

The server 104 is communicatively coupled to at least one buyer 102. Buyer 102 can be an individual, such as, for example, a home owner or business owner, or the buyer 102 can be an organization, such as a business, governmental entity, academic institution, a not-for-profit, waste collection agency, waste aggregator, an entity that acquires bulk waste, and the like. In a preferred embodiment, the buyer 102 is an entity that recycles, repurposes, or otherwise processes waste.

In an embodiment, the buyer 102 can operate a certified waste recycling facility. The buyer 102 can be certified by the platform provider. In an embodiment, the buyer 102 can hold an ISO 14001, OHSAS 18001/ISO 45001, Recycling Industry Operating Standard (RIOS), and/or Responsible Recycling (R2) certification or accreditation.

In an embodiment, the buyer 102 can be audited periodically by the platform provider and/or third-party auditing providers to ensure compliance with any previously obtained certification or accreditation, or for re-certification or re-accreditation purposes.

The buyer 102 can have a computing device 105 that communicatively coupled to a server 104, which may be located remotely from the seller 105. The computing device 105 communicates with the server 104 via a network, such as a wireless network, a cellular network, a landline network, or a short-range connection (i.e., Bluetooth, Zigbee, infrared, etc.).

The server 104 is further communicatively coupled to at least one waste transport provider 116. In an embodiment, the waste transport provider 116 is an individual or entity that is capable of hauling waste from the seller 100, and delivering the waste to the buyer 102. In an embodiment, the waste transport provider 116 may be required to be licensed by a governmental or regulatory authority to handle certain types of waste, such as e-waste, bio-hazardous waste, toxic waste, environmental waste, yard waste, and/or regulated medical waste.

The waste transport provider 116 can include, but is not limited to, entities specializing in waste management, garbage pickup and removal, recycling, hazardous materials disposal and cleanup, disaster restoration and recovery, landscaping and gardening, building demolition, building construction, surveying, moving services, hauling services, short- and long-term storage providers, handyman services, debris removal, and the like.

The waste transport provider 116 can have a computing device 107 that communicatively coupled to a server 104, which may be located remotely from the waste transport provider 116. The computing device 107 communicates with the server 104 via a network, such as a wireless network, a cellular network, a landline network, or a short-range connection (i.e., Bluetooth, Zigbee, infrared, etc.).

FIG. 2 shown an exemplary distributed ledger 114 structure, according to an embodiment of the present invention. In an embodiment, the distributed ledger 114 includes a blockchain network 200, consisting of various individual blocks 202. The number of blocks depicted in FIG. 2 are for illustrative purposes, and the blockchain network 200 can include any number of individual blocks, and is not limited to four blocks. In some embodiments, each block 202 includes a waste lot identifier and/or description of the waste items in the waste lot, along with corresponding transaction data related to the seller 100 and buyer 102. Such transaction data can include, for example, the nature of the transaction, parties to the transaction (i.e., seller, buyer(s), and waste transport provider(s)), document sections, contractual clauses, waste lot sale price, waste lot sale date, waste lot pick-up date, waste lot delivery date, waste lot pick-up location, waste lot delivery location, waste lot transit information, transit surcharge information, blockchain version information, and/or electronic representatives or derivatives of the same.

Each block 202 can include a timestamp indicating when the block 202 was created. In an embodiment, if there is more than one block 202 in the blockchain 200, then every block 202 beyond a first block 202(n) further includes a hash of a previous block in the blockchain 200. For example, block 202(n+1) includes a hash of block 202(n). Different waste lots, each having a unique identifier, can have a dedicate block 202 on the blockchain 200.

The distributed ledger 114 can include a node for each participant on the circular waste economy platform 101, such as a seller node 204, and a buyer node 206. For example, each seller 100 and each buyer 102 that coupled to the server 104 can have a dedicated node on the distributed ledger 114. In an embodiment, each waste transport provider 116 can also have a node on the distributed ledger 114 (not shown). Each participant on the circular waste economy platform 101 may locally maintain a full copy of the distributed ledger 114 for consensus purposes, and/or to be synchronized with the other participant nodes when any change, addition, or deletion is proposed or made to the distributed ledger 114.

In an embodiment, access to the distributed ledger 114 can be restricted to only entities that have been approved, validated, authenticated, or otherwise granted permission by the platform provider to access the circular waste economy platform 101. A potential advantage to limiting access to the distributed ledger 114 to only participants of the circular waste economy platform 101 is that the number of nodes in the distributed network 114 may be reduced (e.g., restricted or limited) in comparison to publicly distributed (or accessible) ledgers. Accordingly, any consensus process, where the nodes, such as seller node 204 and buyer node 206, on the distributed network 114 must agree on any changes made to the distributed ledger 114, may be simplified and the overall performance of the ledger (e.g., transaction speed) may be increased compared to publicly distributed ledgers.

In an embodiment, the platform provider follows protocols and processes for Know Your Customer (“KYC”) purposes, and specifically for identifying and verifying parties participating on the circular waste economy platform 101. For example, the identity of each seller 100, buyer 102, and waste transport provider 116 is verified using, for example, the collection of basic personally identifiable information from each participant (e.g., via a customer identification program), screening of personally identifiable information against global watch-lists to determine adverse issues to the platform provider or other parties on the circular waste recycling economy platform 101, determining a participant's risk in terms of a tendency to commit money laundering, terrorist financing, identify theft, or other illegal, deceptive, or fraudulent purposes, and on-going monitoring of each participant's transaction against expected or common behavior. The platform provider can include processes executed by the server 104 for KYC purposes.

In another embodiment, the platform provider can further ensure that each participant to the circular waste recycling economy platform 101 adheres to Anti-Money Laundering (“AML”) laws and regulations. The platform provider can include a framework of processes executed by the server 104 to ensure compliance with AML.

In an embodiment, a party cannot participate in the circular waste recycling platform 101 if they fail the KYC and/or AML checks and screenings, either at the time of registration with the platform provider, or after the initial registration as part of on-going KYC and AML reviews of participants.

In an embodiment, the circular waste recycling platform 101 is a closed network where access is limited to participants which have been verified, authenticated, or otherwise granted access by the platform provider. In an embodiment, the circular waste recycling platform 101 includes social networking features, where participants can view profiles of other participants, as well as message other participants securely via the DApp.

For example, a more rigorous consensus process may be applied in view of common standards enforced across the entities, or the distributed ledger 114 may be constructed and configured such that greater efficiencies may be obtained during access, traversal, and modification, and the like. In some embodiments, the distributed ledger 114 may be adapted such that the linkages between various blocks 202 are designed to facilitate access and/or traversal of the blockchain 200 in view of operations that may be implemented using, at least in part, information stored in the blockchain 200.

The distributed ledger 114 can further include at least one validator node 208. In an embodiment, the validator node 208 can function to validate smart contracts and/or validate the blockchain. For example, upon receiving a waste lot transaction request from a buyer node 206, validator node 208 can authenticate the identity of buyer node 102, and can further validate the blockchain transaction by checking that buyer node 102 has the required cryptographic credentials to make an update to the distributed ledger 114. Validation of the blockchain transaction may also include verifying whether the buyer 102 has sufficient funds to make the payment and fulfill the smart contract entered into with the seller 100.

In an embodiment, the distributed ledger 114 can include multiple validator nodes (not shown), where each validator node performs a specific type of validation of the waste lot transaction, such as a blockchain validation or smart contract validation.

In yet another embodiment, the platform provider can validate the transaction terms between the seller 100 and buyer 102, as well as with the waste transport provider 116. In such an embodiment, the platform provider can act as the validator node 208 to validate the transaction, without the use of a smart contract being committed to the distributed ledger 114.

For example, in an embodiment, smart contracts are not utilized between the seller 100 and buyer 102, nor with the waste transport provider 116, and the various transactions and details related to, and between, the parties to a waste lot transaction, are stored at or by the platform provider. The platform provider can verify the transaction terms and authorize or deny a transaction from occurring, such as, for example, releasing buyer funds to any parties.

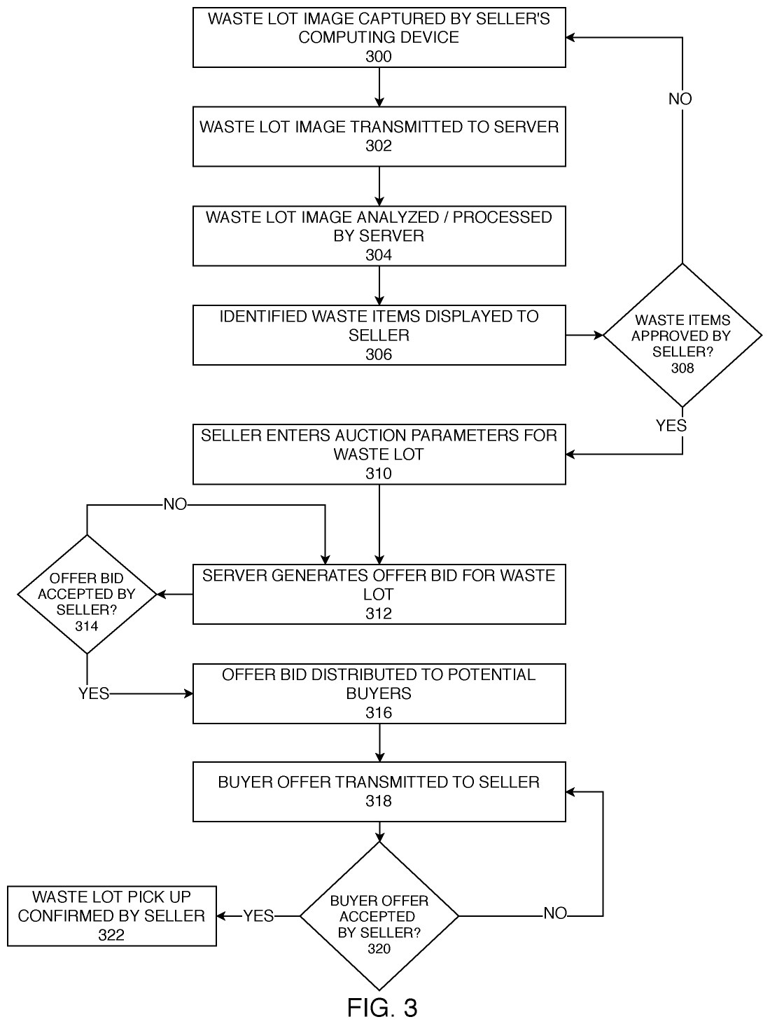

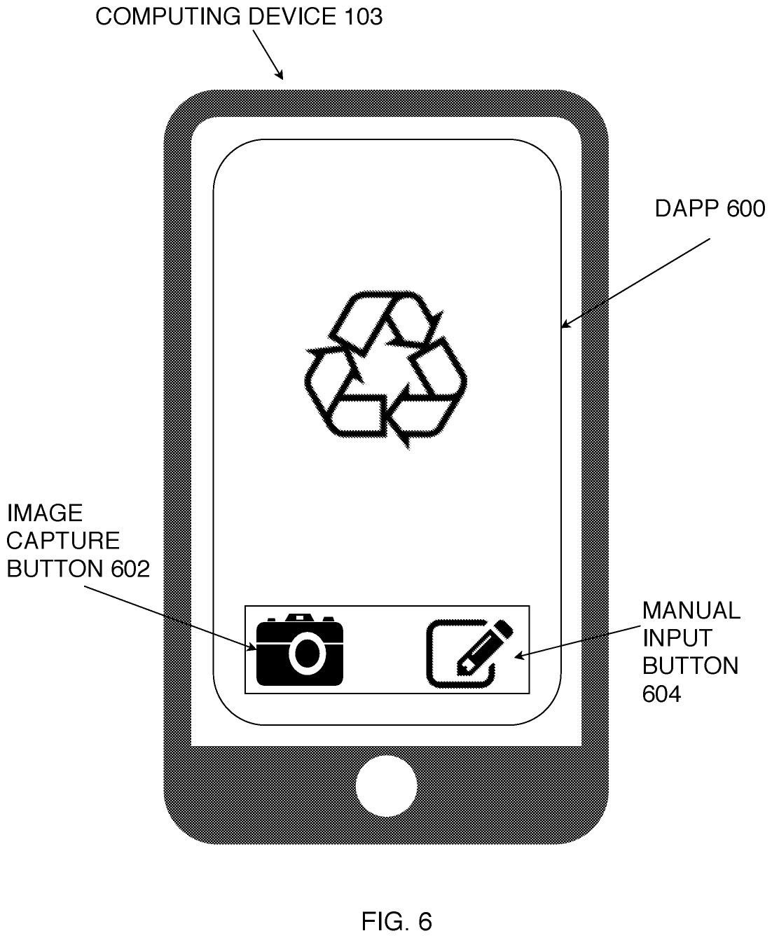

FIG. 3 is a flowchart depicting the steps for conducting an auction for a waste lot, according to an embodiment of the present invention. The computing device 103 can include a software application that is created, operated, and/or distributed by the platform provider, and which enables the computing device 103 to communicate with the server 104 and participate in the circular waste economy platform 101. In an embodiment, the software application is a decentralized application (“DApp”), where the DApp can communicate with the distributed ledger 114 via the server 104. In an embodiment, each participant of the circular waste economy platform 101 operates a DApp via their respective computing device, such that the platform provider can manage the state of all participants via the DApp. Each seller 100, buyer 102, and waste transport provider 116 can access the DApp via their respective computing devices 103, 105, and 107. The DApp is described in more detail herein in FIGS. 6-9.

At step 300, the seller 100 can input data related to the waste lot, such as details, descriptions, and the like, of the waste lot using the computing device 103. In a preferred embodiment, the seller 100 can capture an image of the waste lot using the computing device 103, and specifically, via the DApp. In an embodiment, the computing device 103 is actuated manually by the seller 100 to begin the data capture. In another embodiment, the seller 100 can be located remotely from the computing device 103, and the data capture is initiated via a remote command signal.

In an embodiment, the computing device 103 is configured to automatically capture an image of the waste lot by adjusting and optimizing various optical parameters, such as zoom, frame size, focal length, contrast, color, and lighting/flash. In this embodiment, the computing device 103 can perform edge detection to determine the scene boundaries in order to capture an appropriate region.

In an embodiment, the computing device 103 may include a digital x-ray camera which allows the inspection of waste items that may be stored within the waste lot. For example, in order to determine if hazardous materials are located in the waste lot, the x-ray camera can provide a view inside electronic housings and receptacles, garbage bags, garbage cans, cardboard boxes, and other structures and containers. Items within other items may then undergo item, edge, and spatial detection and recognition as described above, and may subsequently be identified by the server 104.

For example, an x-ray camera can determine if there are batteries, liquids from e-waste, and the like within an electronic housing or receptacle, and can provide a notice to the seller 100 that such items are present in the waste lot. Thus, the entire electronic housing may not be offered for auction or sale, and only the recyclable items within the electrical housing can be sorted appropriately, either by the waste transport provider 116 at the time of a pick-up service, or by the seller 100 prior to a scheduled pick-up service.

In yet another embodiment, the computing device 103 can include a radiation detector in order to detect for hazardous radioactive materials in the waste lot. In another embodiment, the computing device 103 can include an acoustic water detection sensor to detect the presence of liquids which may be contained within items in the waste.

As used herein, the functionality of the computing device 103 and server 104 can be provided via the DApp, such that the DApp can perform the data capture, perform edge detection, image analysis, and the like, and can perform various functions described herein that are provided by the computing device 103 and server 104.

In another embodiment, instead of capturing an image of the waste lot, the seller 100 can manually enter a text description of the waste lot, such as, for example “2 computer screens, 3 cellphones”, and the like. In an embodiment, the DApp can provide autocompletion to predict the remainder of a word that the seller 100 is typing, or to suggest words based on the text that has been entered. In yet another embodiment, the DApp provides a list of items that the seller 100 can select from to describe the waste lot, such as in the form of a drop-down list.

In an embodiment, the seller 100 can enter the description of the waste lot using voice recognition technology integrated with the computing device 104 and/or the DApp. As used herein, the term “captured waste lot image” can refer to an image, video, audio, measurements, text, and the like of the waste lot, as well as data manually input by the seller 100 into the computing device 104 and/or the DApp related to the waste lot.

In an embodiment, the server 104 can use artificial intelligence techniques to suggest waste items based on historical waste lot and waste item data that has been sold or offered for sale by the seller 100.

At step 302 the captured waste lot image is transmitted from the computing device 103 to the server 104. The captured waste lot image may be transmitted/streamed from the computing device 103 in real-time or near real-time, as the computing device 103 is capturing data from the waste lot. In another embodiment, the computing device 103 can capture multiple images or video sequences of the waste lot. For example, the seller 100 may capture a close up of specific waste items in the waste lot, as well as a set-back view from a distance showing multiple waste items and their surrounding environment. In addition, the seller 100 may capture a standard or panoramic view of the waste lot with the computing device 103.

In another embodiment, the computing device 103 can capture data from multiple, different locations containing waste items, where all of the waste items in aggregate is to be offered for sale as a waste lot. For example, the seller 100 may wish to sell a waste lot having waste located in multiple rooms in their home, or at multiple areas at within a corporate facility. In this embodiment, the computing device 103 can transmit data from each waste item location in real time as it is being captured, or alternatively, the computing device 103 can store data captured from each location containing waste items, and transmit all of the aggregated captured waste lot images in a single batch after all image recording or capture is completed.

In yet another embodiment, multiple computing devices located at various locations containing waste items part of an aggregate waste lot can capture data, and transmit the captured waste lot image to a centralized computing device for merging or combining prior to being transmitted to the server 104. In yet another embodiment, such multiple computing devices can each transmit captured waste lot images to the server 104, where the server 104 merges or combines the received data into a single file or batch for analysis.

In addition to audio/visual data which may be captured by the computing device 103, the computing device 103 can be capture various spatial and geographical data related to the waste lot. The location and geographical data of the waste lot can be provided by a location transceiver coupled to the computing device 103, or coupled to the seller 100, or located in the location of where the waste items are location. For example, the geolocation and/or GPS satellite coordinates of the computing device 103 at the time of data capture can be transmitted to the server 104 as metadata associated with the data. The location data may be generated based on a GPS module, by using signal strengths of home and neighboring network cells, by using a subscriber identity module (“SIM”) to obtain raw radio measurements from the mobile device, or by using Wi-Fi data. The location data enables the server 104 to accurately identify the location(s) of the waste lot being offered by the seller 100. In addition, spatial data from various sensors, such as accelerometers, gyroscopes, and depth sensors integrated with, or coupled to, the seller 100 or computing device 103, for example, can also be transmitted along with audio/visual data from the computing device 103 to the server 104.

In an embodiment, terrain mapping sensors may be included in the computing device 103, and can capture and transmit various information related to the geometry, contour, slope, grade, and the like of the environment where the waste lot is located. For example, if the seller 100 desires to have brush and yard waste removed, it may be useful for server 104 to understand the terrain to ensure that a proper waste transport provider 116 having terrain-appropriate vehicles and equipment are dispatched for the waste lot pick-up. In another embodiment, if the seller 100 desires to have e-waste removed that contains, for example, lead-acid lithium ion, and/or rare earth material batteries, it may be useful for the server 104 to ensure that only a waste transport provider 116 that has the proper battery handling and leak-prevention equipment is dispatched for the waste pick-up.

In an embodiment, the seller 100 can tag specific waste items within the waste lot. The tagging process allows the seller 100 to associate a name or description with the waste item, either via text input or verbal input into the computing device 103. The tag data can also be transmitted along with the audio/visual, spatial, and geographical data from the computing device 103 to the server 104 as metadata.

In another embodiment, the computing device 103 may include a radio-frequency identification (“RFID”) reader, barcode scanner, or other optical reading means capable of sensing and decoding an RFID tag or machine-readable code, such as a barcode, quick response (QR) code, or dot matrix code. If any waste items include a RFID tag or machine-readable code, the computing device 103 is capable of reading/interrogating the waste items to obtain their description. The description may include the waste item name, quantity, volume, weight, dimensions, serial number, and any other identifying information, such as a hazardous material designation or special handling instructions. This information may be encoded with the captured waste lot image and transmitted to the server 104 as metadata.

In addition, the seller 100 may provide a requested date and time for a pick-up service, or a plurality of dates and times or a date range, which can be transmitted to the server 104, and provider to prospective buyers 102.

At step 304, the captured waste lot image is analyzed and/or processed by the server 104 to identify waste items in the waste lot. In an embodiment, the server 104, utilizing, for example, the CPU 106, can perform item recognition of the captured waste lot image. Various methods may be applied by the server 104 to perform item recognition. In an embodiment, artificial intelligence techniques are used to extract waste items from the captured waste lot image and compare them to known items/objects and/or historical images of other waste lots and waste items previously analyzed and stored in a database coupled to the server 104.

In another embodiment, the server 104 analyzes various curves, points, contours, boundaries, dimensions, and the like of two-dimensional objects in the captured waste lot image, and creates a three-dimensional representation using, for example, shade modeling. A uniform surface topography can be extracted from the three-dimensional representation, using shape-from-shading techniques.

Other item recognition techniques that can be employed to identify waste items in the captured waste lot image include, for example, edge detection and appearance-based methods that recognize changes in lighting, color, viewing direction, size, and shape, such as edge matching, divide-and-conquer searching, grayscale matching, gradient matching, histograms, and using large model bases. In addition, feature-based methods may also be employed, including, but not limited to, comparison to known items, interpretation trees, hypothesizing and testing, pose consistency, pose clustering, invariance, geometric hashing, and scale-invariant feature transform, and speeded up robust features.

In another embodiment, the server 104 may employ optical character recognition (“OCR”) technologies to read labels on the waste items, such as on cellular phones, gasoline tanks, prescription bottles, batteries, etc., to not only identify waste items, but also to determine if the waste items may be hazardous materials, prohibited items, illegal items, or items that require a surcharge for removal and/or disposal.

In addition to item recognition, the server 104 may employ depth estimation technologies to determine the size, dimensions, volume, and weight of items in the waste. The computing device 103 may include laser ranging, a stereo camera, a coded aperture, or other devices capable of generating a range image that has pixels corresponding to the relative distance in the waste. Other techniques that may be utilized by the computing device 103 and/or the server 104 for depth estimation include, but are not limited to, using a three-dimensional scanner, height-mapping, light-field cameras, photogrammetry, time-of-flight cameras, intensified CCD cameras, and optical flow methods.

In embodiment, the focal length of a camera lens or aperture on the computing device 103 is used in conjunction with a known distance to an item in the waste lot, in order to determine the dimensions of specific waste items. After determining the dimensions of a waste item, a volume of the waste item can be calculated using known mathematical models.

In an embodiment, after a waste item is detected, the waste item may be compared to known items in a database to determine a size, dimensions, volume, weight, or any other characteristic or property associated with the waste item, based on the known waste item data.

Thus, in an embodiment, the server 104 is configured to computationally determine the type, weight, quantity, dimensions, size, and volume of waste items in the waste lot, using, for example, the methods described above.

In an embodiment, the computing device 103 and/or DApp can perform the above described processes to identify waste items in the waste lot, as well as to generate metadata, attributes, and other information may be encoded with the captured waste lot image prior to transmission to the server 104.

In another embodiment, the computing device 103 may be communicatively coupled with a scale, such as via a short-range wireless connection (i.e., Bluetooth, infrared, Zigbee, etc.), or via a hard wire connection (i.e., USB, Firewire, Ethernet, LAN, etc.). The seller 100 can place waste items desired for sale on the scale, and the weight may be automatically transmitted from the scale to the computing device 103, and subsequently, to the server 104. Alternatively, the server 104 may be communicatively coupled to the scale, and the scale may transmit weight data directly to the server 104.

In yet another embodiment, the computing device 103 may determine the volumetric weight of items in the waste items or waste lot using spectroscopy or spectral absorbance measurements.

In an embodiment, the server 104 can determine if the waste lot, or if any waste items in the waste lot, are classified as illegal, prohibited, or contraband. This determination can be made, for example, by the server 104 comparing the detected waste items against a local, state, federal, or international database of hazardous, illegal, or prohibited items, as well as a proprietary database maintained by the server 104. The server 104 can also determine if any detected waste items require a surcharge for removal/disposal, or if any detected waste items are not eligible for sale, pick-up, and/or recycling. In such a scenario, the service 104 displays a notice to the seller 100 via the computing device 103.

In an embodiment, if item recognition fails on a portion of the captured waste lot image, the server 104 can generate a cropped version of these portions of the captured waste lot image. The cropped version is transmitted to the computing device 103 via the server 104 where the seller 100 can have the opportunity to input via the DApp various information related to the unrecognized portions of the captured waste lot image. If the cropped version includes waste items that the seller 100 desires to sell, the seller 100 can input a description, quantity, weight, volume, special handling instructions, dimensions, and the like of the item.

In an embodiment, instead of a cropped version of the waste, the server 104 generates thumbnail images of the portions of the captured waste lot image where item recognition failed (i.e., portions that contain un-identifiable or unrecognizable areas, waste items, and/or objects). In another embodiment, the server 104 highlights portions of the captured waste lot image where item recognition failed. In yet another embodiment, the server 104 enlarges or zooms-in on portions of the captured waste lot image where item recognition failed

After the seller 100 provides sufficient information related to the portions of the captured waste lot image where item recognition failed, the information is transmitted to the server 104 for analysis and review.

At step 306, the server 104 transmits a list of identified waste items from the captured waste lot image to the computing device 103. In an embodiment, the list can be a text list which specifies the quantity and description of each identified waste item, such as for example, “2 computer screens, 3 cellphones”, and the like. In another embodiment, the list can be depicted by highlighting, circling, outlining, or otherwise indicating the identified waste items in an image that is transmitted to, and displayed on, the computing device 103. In another embodiment, the list can include graphical representations or icons depicting each waste item, or can include an actual thumbnail or cropped version of the waste item from the captured waste lot image.

At step 308, the seller 100 is prompted to accept, decline, or edit the list of identified waste items. For example, if the seller 100 no longer wishes to sell a particular waste item that was originally included in the waste lot, the seller 100 can remove that particular waste item from the list. In an embodiment, the seller 100 can modify a quantity of a specific waste item to sell. For example, if the server 104 identifies “2 computer screens”, the seller 100 can modify the quantity to only offer “1 computer screen” for sale.

In an embodiment, if the seller 100 declines the entire list of identified waste items, the process returns to step 300 where the seller 100 is prompted to input data related to the waste lot using the computing device 103.

If, however, the seller 100 accepts the list of identified waste items, either as-is, or as-modified by the seller 100, then at step 310, the seller 100 is prompted to enter auction details. In an embodiment, the auction details can include, but is not limited to, a start minimum bid, a reserve bid, a bid increment amount, an auction timeframe, an auction start time, and an auction end time. The reserve bid is a contractual amount at which the seller 100 guarantees to sell the waste lot if a buyer's offer/bid is at least as much as the reserve bid. The reserve bid may or may not be made known to potential buyers 102.

In an embodiment, the seller 100 can specify that buyers 102 must purchase the entire waste lot, i.e., an “all or nothing sale”, or alternatively, that buyers 102 can bid or, and purchase, specific waste items in the waste lot, and not the entire waste lot.

At step 312, the server 104 generates an offer bid based, at least in part, on the auction details and the waste lot. In addition, the server 104 can further utilize commodities pricing data, historical and real-time waste supply and demand data, historical sales data, and the like, to generate an offer bid. In addition, the volume, size and/or weight of the waste lot, along with waste transport costs (such as, for example, fuel costs, labor costs, tolls, etc.) and recycling/dumping fees and taxes can be utilized by the server 104 to generate an offer bid.

In an embodiment, the server 104 utilizes artificial intelligence techniques to generate an offer bid, based, at least in part, on historical offer bids and waste lot transaction data.

In an embodiment, the offer bid can be presented in various currencies, such as fiat currencies (US dollars, Euro, Peso, Yen, Yuan, Ruble, Rupee, and the like), and non-fiat currencies including virtual currencies including cryptocurrencies and token (Bitcoin, Ethereum, Tether, Ripple, Litecoin, Nano, Stellar, Cardano, Monera, and the like), commercial paper (loans, contracts, notes, and the like), and securities (stocks, bonds, derivatives, and the like). The use of virtual or digital currency can provide anonymity between the seller 100, buyer 102, and waste transport provider 116.

In an embodiment, the offer bid is presented in a digital currency that is native to, and offered by, the platform provider. The digital currency can be specific to the circular waste economy platform 101, and can be utilized to exchange goods and services on the circular waste economy platform 101, as well as exchanged for fiat currencies and/or other virtual currencies, including cryptocurrencies. In an embodiment, the platform provider can provide currency exchange services and allow participants to exchange, for example, virtual currencies for fiat currencies.

In another embodiment, the offer bid can be displayed to the seller 100 on the DApp. The offer bid can be displayed in a first currency specified by the server 104, as well as in equivalent values of other currencies. For example, if the server 104 provides an offer bid in Bitcoin, the US dollar equivalent of the Bitcoin can also be displayed to the seller 100.

At step 314, the seller 100 can either accept, reject, or counter the offer bid provided by the server 104. If the seller 100 rejects the offer bid, then the process ends. If, however, the seller 100 enters a counter bid to the offer bid, then the counter bid is transmitted to the server 104, and the process returns to step 312 where the server 104 analyzes the counter bid, and proceeds to either accept, reject, or counter the counter bid.

If, however, the seller 100 accepts the offer bid, then the process continues to step 316 where the server 104 distributes the offer bid to potential buyers 102 participating on the circular waste economy platform 101. The offer bid can be displayed to the potential buyers 102 on the DApp executing on their respective computing device 105.

In an embodiment, the server 104 can match buyers 102 with the waste lot based on profiles associated with each buyer 102. A buyer profile can include, but is not limited to, a name, an entity status (e.g., public, private, non-profit, government military, government non-military, self-employed), a size based on revenue, a purchasing budget, a preferred waste type(s), a location or geographic preference for sellers, preferred seller names, blacklisted sellers, a maximum price the buyer is willing to spend any waste lot, and the like.

In an embodiment, each seller 100 can also have a seller profile. A seller profile can include, but is not limited to, a name, an entity status, a size based on revenue, types of waste generated by the seller, a location or geographic preference for buyers, preferred buyer names, blacklisted buyers, and the like. For example, a seller 100 may prefer to deal only in large scale or wholesale transactions with government organizations because they are organized to efficiently and legally handle such larger-scale transactions, while another seller 100 may prefer to deal only in small scale or retail and non-government transactions because they are organized to more efficiently handle these smaller-scale types of transactions.

Thus, the server 104 can utilize one or both of a buyer profile and a seller profile in order to match a seller 100 with potential buyers 102. In an embodiment, the server 104 can leverage artificial intelligence techniques that utilize historical waste lot transaction data in order to identify and match potential buyers 102 that may have the most interest in, or have a higher likelihood of bidding on, the waste lot. The respective buyer profile and seller profile can be managed accessed, updated, and edited by a buyer 102 and a seller 100 via the DApp.

At step 318, a buyer 102 can transmit an offer on the waste lot. The buyer 102 can either accept the offer bid that was transmitted by the server 104, or alternatively, make a counter offer (collectively, the “Buyer Offer”). At step 320, the seller 100 can either accept, reject, or counter the Buyer Offer. If the seller 100 rejects the Buyer Offer, then the process ends.

If, however, the seller 100 enters a counter offer (“Seller Counter Offer”) to the Buyer Offer, then the Seller Counter Offer is transmitted to the buyer 102, and the process returns to step 318 where the buyer 102 can review the Seller Counter Offer, and can either accept, reject, or counter the Seller Counter Offer.

In an embodiment, multiple buyers 102 can transmit offers for specific waste items in the waste lot, such that no single buy purchases the entire waste lot.

If, however, the seller 100 accepts the Buyer Offer, then, in an embodiment, a smart contract is generated that contains the transaction price, transaction date, the parties involved, details of the waste lot, and the like. The smart contract is submitted to the validator node 208 and stored on the distributed ledger 101 upon a successful validation. Then at step 322, the server 104 then prompts the seller 100 to confirm a pick-up time for the waste lot to be hauled to the waste transport provider 116.

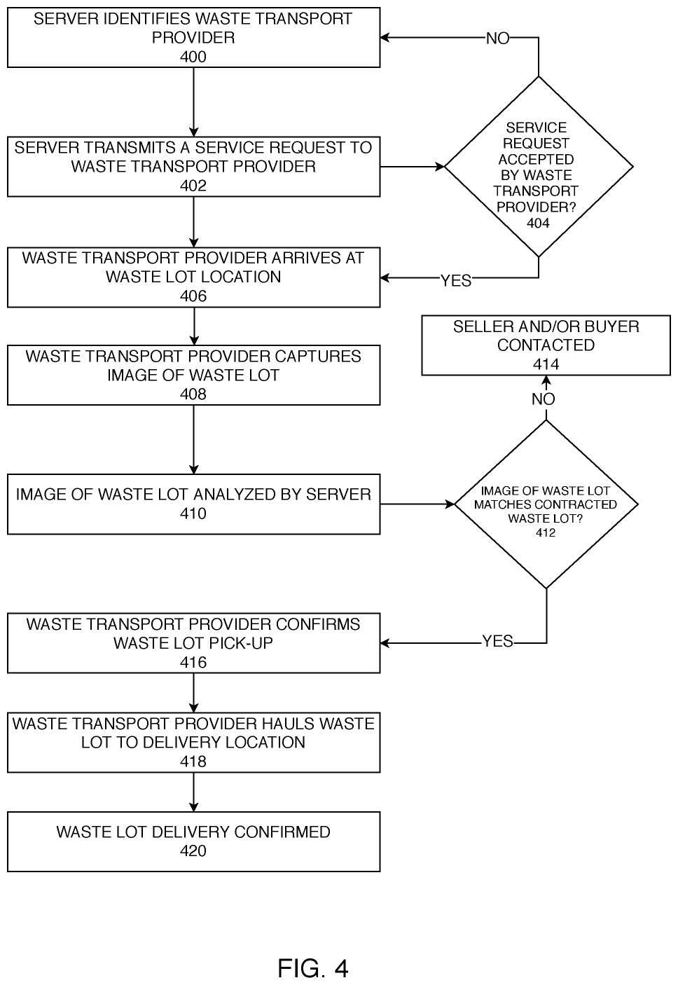

FIG. 4 is a flowchart depicting the steps for scheduling a waste transport provider and fulfilling a waste lot pick-up and delivery, according to an embodiment of the present invention. At step 400, the server 104 identifies a waste transport provider 116 to be retained for picking up the waste lot purchased by the buyer 102. In an embodiment, the server 104 identifies a waste transport provider 116 by matching the waste lot with a profile associated with each waste transport provider 116. A waste transport provider profile can include, but is not limited to, a vehicle type, vehicles types in a fleet, a location, a service radius or area, a minimum service cost, a maximum load volume and/or weight, preferred waste types, unaccepted waste types, license information (such as, for example, a license or authority to handle certain types of waste, such as e-waste, bio-hazardous waste, toxic waste, environmental waste, yard waste, and/or regulated medical waste), preferred service days and/or times, service surcharges (such as, for example, for large or bulky waste items, for hazardous waste items, etc.), preferred seller names, preferred buyer names, blacklisted sellers, blacklisted buyers, preferred form and/or currency of payment, and the like.

In an embodiment, the server 104 can further utilize the service date for the waste lot, the seller and/or waste lot location, the buyer and/or delivery location, fuel costs, traffic patterns, weather data, and the availability of service vehicles and employees for each potential waste transport provider 116 to match a waste transport provider 116 to the waste lot transaction.

In an embodiment, the server 104 can further utilize real-time location data for each potential waste transport provider 116, in order to determine estimated travel times to a pick-up location and to a delivery location, in order to match a waste transport provider 116 to the waste lot.

In yet another embodiment, the server 104 can identify multiple waste transport providers 116 to provide service on a single waste lot, where each waste transport provider 116 is assigned specific waste items from the waste lot, or is assigned a certain percentage, volume, or weight of the waste lot to haul.

In another embodiment, the server 104 can utilize a matching algorithm to identify and rank waste transport providers 116, such that a back-up waste transport provider can be selected and placed “on call” in the event the matching waste transport provider is unable to fulfill its service obligation, or if the matching waste transport provider does not accept the service request.

At step 402, the server 104 transmits a service request to a waste transport provider 116. The service request can include, for example, details related to the waste lot, a pick-up location and a delivery location, and the service date. The server 104 can further offer a payment amount to the waste transport provider 116 with the service request. The payment amount can be a fixed, pre-determined or pre-negotiated rate that the waste transport provider 116 has agreed to with the platform provider, seller 100, and/or buyer 102.

In an embodiment, the payment amount can be a percentage of the transaction price, where the percentage can be determined by the server 104, and based on estimated or actual fuel costs, disposal costs, recycling costs, tolls and/or surcharges, estimated or actual labor costs for the waste transport provider 116, estimated or actual overhead costs for the waste transport provider 116, and the like.

The server 104 can further consider surcharges applied by a waste transport provider 116 for after-hours service, weekend service, or holiday service, when calculating the payment amount.

In yet another embodiment, the server 104 can distribute the service request to multiple potential waste transport providers 116 participating on the circular waste economy platform 101. Each waste transport provider 116 can bid on the service request, in a similar fashion as described in FIG. 3 whereby buyers 102 bid on waste lots. In an embodiment, a waste transport provider 116 that is the first to accept the service request can be selected by the server 104 to fulfill the service request.

In step 404, if the waste transport provider 116 does not accept the service request, then the process returns to step 402, wherein the server 104 can select a back-up waste transport provider or providers to transmit the service request to.

In an embodiment, the waste transport provider 116 can modify the service request, such as by proposing an alternate service date(s), requesting a different payment amount, and the like. If the waste transport provider 116 modifies the service request, the modified service request is transmitted to the server 104 for review, and the server 104 can accept, reject, or counter the modified service request.

If, however, the waste transport provider 116 accepts the service request, then at step 406, the waste transport provider 116 arrives at the location of the waste lot on the service date. At step 408, the waste transport provider 116 can capture an image of the waste lot using their computing device 107, and specifically via the DApp executing on the computing device 107.

At step 410, the server 104 analyzes the captured image of the waste lot to confirm that the actual waste lot matches the waste lot in the smart contract. The server 104 can utilize item recognition techniques described herein to analyze the captured image of the waste lot. In an embodiment, the DApp can perform the data capture, perform edge detection, image analysis, and the like, and can perform various functions described herein that are provided by the server 104.

At step 412, the server 104 determines if the actual waste lot matches the waste lot in the smart contract. In an embodiment, the server 104 requires a complete match of the actual waste lot and the waste lot in the smart contract. In another embodiment, if the server 104 determines that the actual waste lot matches the waste lot in the smart contract by a certain threshold, such as by 90% or more, then the server 104 considers this to be a match.

If the server 104 does not identify a match, then the seller 100 and/or the buyer 102 are contacted to determine the discrepancy at step 414. In an embodiment, the seller 100 may have an opportunity to modify the waste lot, and/or the seller 100 and buyer 102 may have an opportunity to adjust the transaction price based on the difference between the actual waste lot and the waste lot in the smart contract.

If, however, the server 104 does identify a match, then at step 416, the waste transport provider 116 confirms that pick-up of the waste lot via confirming the pick-up in the DApp on their computing device 107. In another embodiment, the waste transport provider 116 can confirm the pick-up of the waste lot via a phone call, text message, MMS message, electronic message, social networking message, and the like, to the server 104, the seller 100, and/or the buyer 102.

Next, at step 418, the waste transport provider 116 hauls the waste lot to a delivery location, which can be located physically with the buyer 102, or which can be located remotely from the buyer 102. In an embodiment, the waste transport provider 116 delivers the waste lot to multiple locations specified by the buyer 102.

At step 420, upon delivery of the waste lot, the waste transport provider 116 can confirm the delivery of the waste lot via confirming the delivery in the DApp on their computing device 107. In another embodiment, the waste transport provider 116 can confirm the delivery of the waste lot via a phone call, text message, MMS message, electronic message, social networking message, and the like, to the server 104, the seller 100, and/or the buyer 102.

In an embodiment, the buyer 102 can provide a confirmation of the delivery of the waste lot using the DApp on their computing device 105. In another embodiment, the buyer 102 can confirm the delivery using the DApp operating on the waste transport provider's computing device 107.

In an embodiment, upon confirmation of a waste lot pick-up and delivery, the smart contract is updated and validated by the validator node 208. Upon validation, the pick-up and delivery details, such as the dates and times, waste lot discrepancies, notes, waste transport provider information, and the like, are committed to the block that contains the smart contract, thereby updating the distributed ledger 114.

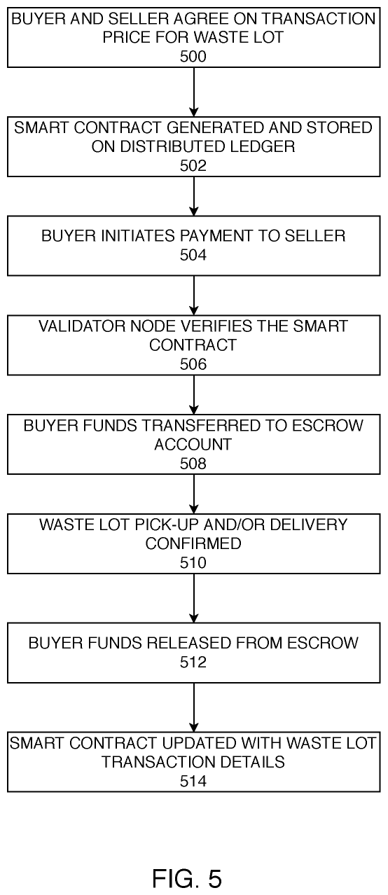

FIG. 5 is a flowchart depicting the steps of conducting a financial transaction for the transfer of a waste lot utilizing a distributed ledger 114, according to an embodiment of the present invention. At step 500, the seller 100 and buyer 102 agree on a transaction price for a waste lot (i.e., the seller 100 has accepted the Buyer Offer, or the buyer 102 has accepted the Seller Counter Offer). At step 502, a smart contract is generated for a sale of the waste lot, where the smart contract contains the transaction price, transaction date, the parties involved, details of the waste lot, and the like. The smart contract is submitted to the validator node 208 and stored on the distributed ledger 101 upon a successful validation.

At step 504, the buyer 504 can initiate a funds transfer of the transaction price. The funds transfer can be made in various currencies, such as fiat currencies (US dollars, Euro, Peso, Yen, Yuan, Ruble, Rupee, and the like), and non-fiat currencies including virtual currencies including cryptocurrencies (Bitcoin, Ethereum, Tether, Ripple, Litecoin, Nano, Stellar, Cardano, Monera, and the like), commercial paper (loans, contracts, notes, and the like), and securities (stocks, bonds, derivatives, and the like).

In an embodiment, the funds transfer is made in a digital currency that is native to, and offered by, the platform provider. The digital currency can be specific to the circular waste economy platform 101, and can be utilized to exchange goods and services on the circular waste economy platform 101, as well as exchanged for fiat currencies and/or other virtual currencies, including cryptocurrencies.

At step 506, the validator node 208 verifies that the smart contract for the waste lot is valid and active. For example, the validator node 208 can authenticate the identity of buyer node 102 and the seller node 100, and can further validate the blockchain transaction by checking that buyer node 102 has necessary cryptographic credentials to make an update to the distributed ledger 114. Validation of the smart contract may also include verifying whether the buyer 102 has sufficient funds placed in the escrow account equaling the payment amount, and that such funds can fulfill the smart contract entered into with the seller 100.

At step 508, after the smart contract related to the smart lot is validated, then the payment is transferred from the buyer 102 to an escrow account managed by the platform provider (e.g., the platform provider acts as an escrow agent). In an embodiment, the escrow account is managed by a third-party escrow provider that is not affiliated with the platform provider. The escrow account serves to protect the seller 100 by ensuring that the buyer 102 has readily available funds to complete the purchase of the waste lot. Similarly, the escrow account serves to protect the buyer 102 by ensuring that the buyer's funds in escrow are not released to the seller 100 until waste lot is delivered to the buyer 102, or the waste lot is picked up by the waste transport provider 116.

At step 510, the server 104 confirms that the actual waste lot matches the waste lot in the smart contract, and after either (1) the waste lot is delivered to the buyer 102, and/or (2) the waste lot is picked up by the waste transport provider 116. At step 512, the buyer's funds are released from the escrow account. The server 104 can compensate the waste transport provider 116, the platform provider, and any other entities involved in the waste lot transaction, such as, for example, a third-party escrow provider. The remaining balance of the buyer's funds are then released to the seller 100 to complete the waste lot transaction.

In an embodiment, the platform provider can release the buyer's funds from the escrow account prior to such confirmation in order to pay the waste transport provider 116 in advance, if necessary. In an embodiment, the buyer 102 may be required in good faith to pay a deposit of the transaction price to the seller 100 prior to the waste lot being picked up by the waste transport provider 116. In this embodiment, the balance of the transaction price can be placed into the escrow account, and released as described in step 510.

In an embodiment, the buyer's funds are converted from a first currency to a second currency prior to being deposited into the escrow account. For example, if the buyer 102 transfers funds in the form of, for example, 10 Bitcoin, then the 10 Bitcoin can be converted to a fiat currency, such as US dollars, prior to being deposited into the escrow account. By converting, for example, a digital currency that may be prone to significant price fluctuations, into a more stable, and less volatile, fiat currency, the risk of the buyer's funds losing value prior to the waste lot transaction being completed is mitigated.

In an embodiment, the platform provider and/or third-party escrow provider may require that the buyer 102 deposit an amount in addition to the transaction amount into the escrow account. Such additional amount may be used as a commission and/or fees payable to the platform provider and/or third-party escrow provider. In an embodiment, the additional amount may also be used to cover any transaction fees, such as fees resulting from converting a digital currency into a fiat currency, and vice versa.

In an embodiment, a buyer's funds may be converted to another currency prior to release from the escrow account. For example, if the buyer's funds are in US dollars while in the escrow account, and the seller 100 is to be paid in a digital currency, the US dollars are converted to the digital currency prior to being sent to the seller 100.

At step 514, the server 104 confirms that the funds transfer between the buyer 102 and the seller 100 has been completed, as well as that all entities involved in the waste lot transaction have been compensated. Upon such confirmation, the smart contract is updated and validated by the validator node 208. Upon validation, the escrow funding and funds release dates and times, fund transfer confirmation numbers, the amount of funds transferred to each involved entity, the fund currency prior to escrow, the fund currency in escrow, the fund currency after release from escrow, and the like, are committed to the block that contains the smart contract, thereby updating the distributed ledger 114. In an embodiment, the pick-up and delivery dates and times of the waste lot by the waste transport provider 116 are recorded in the smart contract.

FIG. 6 is an exemplary diagram of a DApp interface that allows a seller to input a waste lot, according to an embodiment of the present invention. The seller 100 can launch the DApp 600 on their computing device 103. The DApp allows the seller 100 to input data related to the waste lot, such as details, descriptions, and the like, of the waste lot using the computing device 103. In a preferred embodiment, the seller 100 can select the image capture button 602 to initiate capture an image of the waste lot using a camera or recording device integrated with, or coupled to, the computing device 103. In an embodiment, the seller 100 has the option to manually input the data by selecting the manual input button 604.

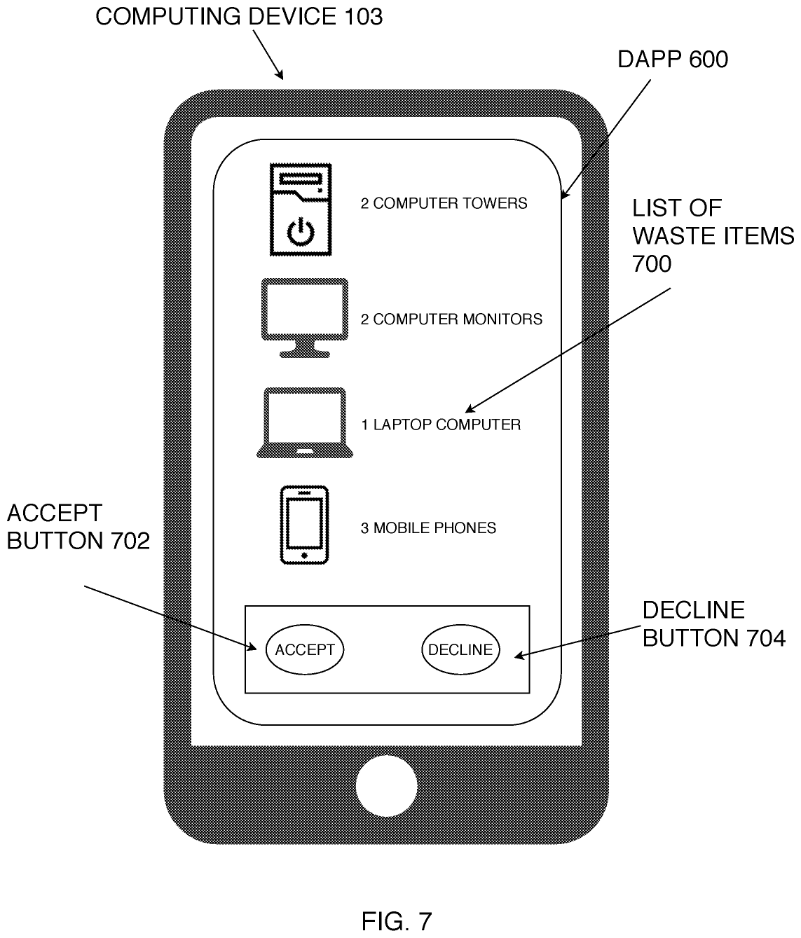

FIG. 7 is an exemplary diagram of a DApp interface that displays a list of waste items in a waste lot, according to an embodiment of the present invention. In an embodiment, the list of waste items 700 can be generated by the server 104 using various item recognition techniques, as discussed herein at step 304, and displayed on the DApp 600. The seller 100 can select the accept button 802 to confirm that the list of waste items 700 is accurate, or alternatively, the seller 100 can select the decline button 804 if the list of waste items 700 is in-accurate, incomplete, or otherwise incorrect. In an embodiment, if the seller 100 declines the entire list of identified waste items, the process returns to step 300 as shown in FIG. 3 where the seller 100 is prompted to input data related to the waste lot using the computing device 103.

For example, if the seller 100 no longer wishes to sell a particular waste item that was originally included in the waste lot, and displayed in the list of waste items 700, the seller 100 can remove that particular waste item from the list of waste items 700. In an embodiment, the seller 100 can modify a quantity of a specific waste item to sell. For example, if the server 104 identifies “2 computer screens”, the seller 100 can modify the quantity to only offer “1 computer screen” for sale.

In an embodiment, the seller 100 can modify the list of waste items 700 in real-time, such as by modifying the quantity of each waste item detected by the server 104, as well as the description of each waste item detected by the server 104. In an embodiment, the seller 100 can delete any of the waste items in the list of waste items 700. In the event of a modification to the list of waste items 700 by the seller 100, the modified list of waste items is transmitted to the server 104 for review and/or approval.

It is noted that although FIG. 7 is depicts e-waste in the list of waste items 700, it is understood that the invention could be implemented for any type of waste in any setting where the transfer, transport, sale, and/or recycling of any type of waste or by-products is desired.

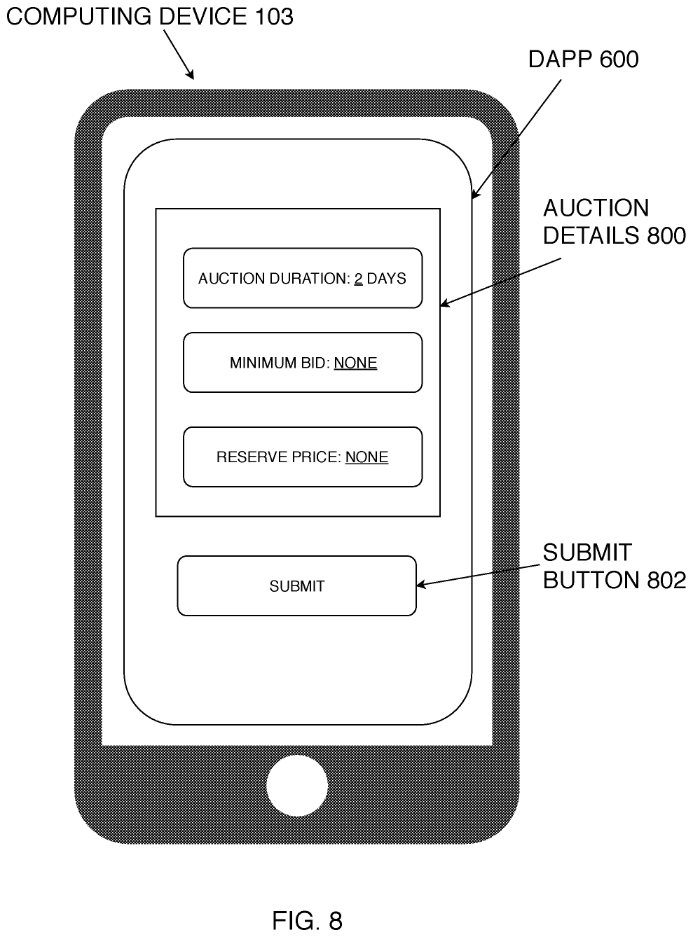

FIG. 8 is an exemplary diagram of a DApp interface that allows a seller to input auction details, according to an embodiment of the present invention. In an embodiment, the auction details 800 can include, but is not limited to, a start minimum bid, a reserve bid, a bid increment amount, an auction timeframe, an auction start time, and an auction end time. The reserve bid is a contractual amount in that the seller 100 is promising to sell the waste lot if a winning bid is at least as much as the specified reserve bid. The specified reserve bid may or may not be made known to potential buyers 102.

In an embodiment, the seller 100 can specify that buyers 102 must purchase the entire waste lot, i.e., an “all or nothing sale”, or alternatively, that buyers 102 can bid or, and purchase, specific waste items in the waste lot.

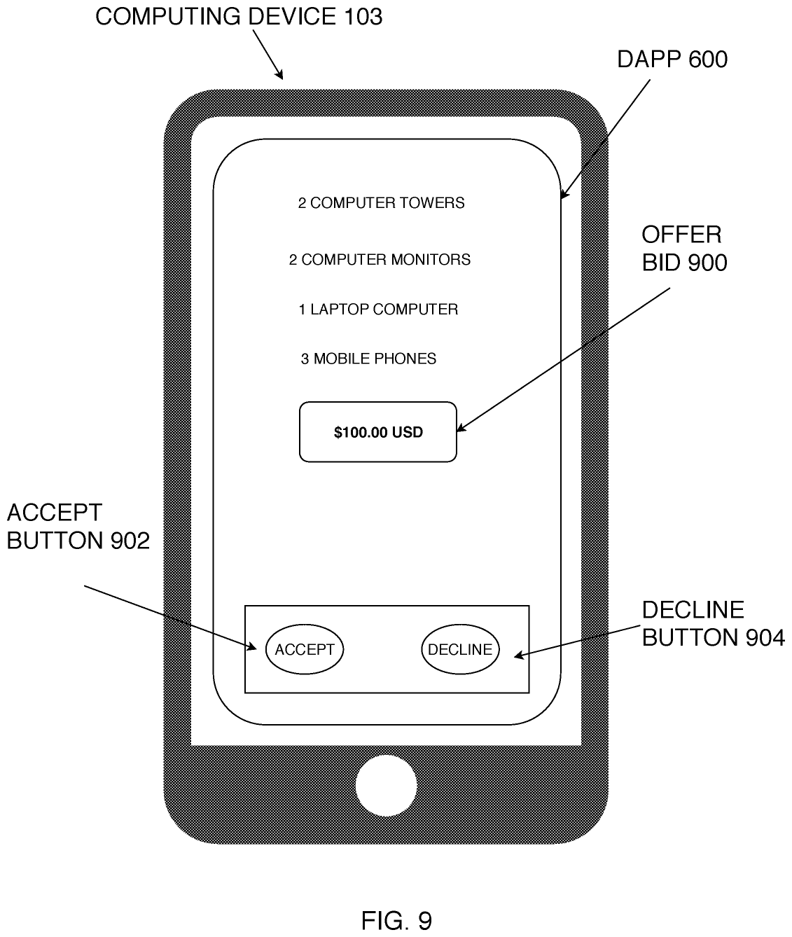

FIG. 9 is an exemplary diagram of a DApp interface that allows a seller to review an offer bid for a waste lot, according to an embodiment of the present invention. In an embodiment, the offer bid 900 generated by the server 104, as discussed herein at step 312, is displayed on the DApp 600.

In an embodiment, the offer bid 900 can be presented in various currencies, such as fiat currencies (US dollars, Euro, Peso, Yen, Yuan, Ruble, Rupee, etc.), and non-fiat currencies including virtual currencies including cryptocurrencies (Bitcoin, Ethereum, Tether, Ripple, Litecoin, Nano, Stellar, Cardano, Monera, and the like), commercial paper (loans, contracts, notes, and the like), and securities (stocks, bonds, derivatives, and the like).

In an embodiment, the offer bid 900 is presented in a digital currency that is native to, and offered by, the platform provider. The digital currency can be specific to the circular waste economy platform 101, and can be utilized to exchange goods and services on the circular waste economy platform 101, as well as exchanged for fiat currencies and/or other virtual currencies, including cryptocurrencies.

In another embodiment, the offer bid 900 can be displayed in a first currency specified by the server 104, as well as in equivalent values of other currencies. For example, if the server 104 provides an offer bid in Bitcoin, the US dollar equivalent of the Bitcoin can also be displayed to the seller 100.

In an embodiment, the seller 100 can accept the offer bid 900 by selecting the accept button 902, or can decline the offer bid 900 by selecting the decline button 904. In an embodiment, the seller 100 can enter a counter to the offer bid 900, reject, or counter the offer bid provided by the server 104. If the seller 100 rejects the offer bid, then the process ends. If, however, the seller 100 enters a counter bid to the offer bid, then the counter bid is transmitted to the server 104, and the process returns to step 312 of FIG. 3 where the server 104 analyzes the counter bid, and proceeds to either accept, reject, or counter the counter bid.

In an embodiment, computing devices 105 and 107 operated by the buyer 102 and waste transport provider 116 can launch and execute a similar DApp that has functionality allowing those parties to review offers, provide counter-offers, and confirm or decline transactions, as described herein.

In an embodiment, the DApp 600 may display advertisements for various other third-parties services, such as for moving services, landscaping services, real estate listing, home renovation services, etc. The platform provider, buyer 100, and/or seller 102 may receive advertising fees from parties placing the advertisements, and may also receive click-through fees when advertisements are selected by participants of the circular waste economy platform 101.

In another embodiment, the DApp 600 can provide a communication interface, such as a chat feature, secure messaging portal, instant message feature, group chat feature, and the like, that allows participants in the circular waste economy platform 101 to communicate via the DApp 600. For example, the DApp 600 can allow a buyer 102 to securely and confidentially and anonymously communicate with the seller 100, without the buyer and/or seller names, contact information, identifying information, location, etc. being revealed or disclosed to either party. The DApp 600 can allow for voice, video, e-mail, text message, and/or social network messaging between the participants in the circular waste economy platform 101.

In another embodiment, the seller 100, buyer 102, and waste transport provider 116 can participate in a group chat once a waste lot pick-up and/or delivery is underway.

In yet another embodiment, the seller 100 and/or buyer 102 can track the status and location of the waste transport provider 116 via the DApp 600. For example, the real-time location of the waste transport provider 116 can be displayed on a graphical map interface within the DApp 600, as well as estimate arrival, pick-up, and delivery times for the waste transport provider 116.

In an embodiment, each participant in the circular waste economy platform 101 can have a graphical avatar, caricature, logo, picture, photograph, and the like, that is displayed in the DApp 600, and displayed to other participants using the DApp 600.

While the principles of the disclosure have been illustrated in relation to the exemplary embodiments shown herein, the principles of the disclosure are not limited thereto and include any modification, variation or permutation thereof.

What is claimed is:

1. A system for a circular waste recycling economy platform, comprising:
a server comprising a central processing unit (CPU);
at least one seller communicatively coupled to the server, wherein the seller owns a waste lot;
a plurality of buyers communicatively coupled to the server;
a plurality of waste transport providers communicatively coupled to the server; and
a distributed ledger communicatively coupled to the server,
wherein the server is further configured to match the waste lot to at least one buyer using an artificial intelligence technique, and
wherein the server is configured to transmit an offer to sell the waste lot from the seller to the at least one buyer that is matched by the server, and
wherein the server is further configured to generate a smart contract for a sale of the waste lot between the seller and the at least one buyer, and
wherein the distributed ledger is configured to store the smart contract.

2. The system of claim 1, wherein the distributed ledger is configured to validate the smart contract prior to storing the smart contract.

3. The system of claim 1, wherein the buyer is configured to transmit an image of the waste lot to the server.

4. The system of claim 3, wherein the server is configured to perform item recognition on the waste lot to identify at least one waste item in the waste lot.

5. The system of claim 1, wherein the server is further configured to select at least one waste transport provider to pick-up the waste lot from the seller, and to deliver the waste lot to the at least one seller.

6. The system of claim 1, wherein the at least one seller purchases the waste lot from the seller using a virtual currency.

7. The system of claim 1, wherein the server is configured to be an escrow agent between the seller and the at least one buyer.

8. A method for conducting waste transactions, comprising:
receiving, at a server, an image of a waste lot from a waste seller;
analyzing, by the server, the image of the waste lot to identify at least waste item in the image;
generating, by the server, an offer bid for the waste lot, wherein the offer bid is generated using an artificial intelligence technique;
transmitting, by the server, the offer bid to the waste seller;
executing, by the server, a first operation to transmit the offer bid to a plurality of waste buyers communicatively coupled to the server if the waste seller approves the offer bid, or executing, by the server, a second operation to analyze a counter bid from the waste seller if the waste seller rejects the offer bid;
accepting, by a waste seller, the offer bid;
generating, by the server, a smart contract for a sale of the waste lot between the waste seller and the waste buyer;
storing, by the server, the smart contract on a distributed ledger communicatively coupled to the server;
identifying, by the server, a waste transport provider to service the sale of the waste lot;
receiving, by the server, funds from the waste buyer to fulfill the smart contract;
distributing, by the server, the funds to the waste seller and the waste transport provider upon confirmation of a delivery of the waste lot to the waste buyer by the waste transport provider; and
updating, by the server, the smart contract with at least one of a waste lot delivery confirmation and a funds transfer confirmation.

9. The method of claim 8, wherein an identity of least one of the waste seller, the waste buyer, and the waste transport provider is verified by the server.

10. The method of claim 8, wherein the funds are in the form of a virtual currency.

11. The method of claim 8, wherein the funds are exchanged from a first currency to a second currency by the server.

12. The method of claim 8, wherein the server identifies the waste transport provider using an artificial intelligence technique to match the waste transport provider to the smart contract based on properties of at least one of the waste seller, the waste buyer, and the waste lot.

13. The method of claim 8, wherein the waste seller and the waste buyer communicate with the server using a decentralized application (DApp).

14. A system for a circular waste recycling economy platform, comprising:
a server communicatively configured to operate a closed network accessible only to entities that have been granted access to the closed network by the server;
a seller decentralized application (DApp) operated by a waste seller, the seller DApp communicatively coupled to the server;
a buyer DApp operated by a waste buyer, the buyer DApp communicatively coupled to the server;
a distributed ledger communicatively coupled to the server; and
a central processing unit (CPU) coupled to the server, wherein the CPU is configured to match the waste buyer to the waste seller using an artificial intelligence technique,
wherein the server is configured to transmit an offer bid for a waste lot for sale by the waste seller to the waste buyer,
wherein the server is further configured to transmit at least one of an acceptance and a counter offer from the waste buyer to the waste seller,
wherein the server is further configured to generate a smart contract for the sale of the waste lot between the waste buyer and the waste seller, where the smart contract is stored on the distributed ledger, and
wherein the server is further configured to act as an escrow agent to hold funds from the waste buyer until the waste lot is successfully delivered to the waste seller.

15. The system of claim 14, wherein the server is configured to verify an identity of the waste seller using at least one of a Know Your Customer (KYC) and Anti-Money Laundering (AML) process.

16. The system of claim 14, wherein the server is configured to verify an identity of the waste buyer using at least one of a KYC and AML process.

17. The system of claim 14, further including a waste transport provider DApp operated by a waste transport provider, the waste transport provider DApp communicatively coupled to the server.

18. The system of claim 14, wherein the DApp is distributed to the waste buyer and waste seller by a provider that manages the circular waste recycling economy platform.

19. The system of claim 14, wherein the funds are in the form of a virtual currency.

20. The system of claim 14, wherein the distributed ledger is comprised of a blockchain, where each block on the blockchain is configured to store a separate smart contract.
